(19) United States
(12) Patent Application Publication
(10) Pub. No.: US 2026/0188584 A1
(43) Pub. Date: Jul. 2, 2026

(54) MULTILAYER ELECTRONIC COMPONENT

(71) Applicant: SAMSUNG ELECTRO-MECHANICS CO., LTD., Suwon-si (KR)

(72) Inventors: Dong Geon Yoo, Suwon-si (KR); Jong Hoon Yoo, Suwon-si (KR)

(73) Assignee: SAMSUNG ELECTRO-MECHANICS CO., LTD., Suwon-si (KR)

(21) Appl. No.: 19/364,685

(22) Filed: Oct. 21, 2025

(30) Foreign Application Priority Data
Dec. 26, 2024 (KR) 10-2024-0197581

(51) Int. Cl. H01G 4/232; H01G 4/012; H01G 4/12; H01G 4/30

(52) U.S. Cl. CPC H01G 4/232; H01G 4/012; H01G 4/12; H01G 4/30

(57) ABSTRACT

A multilayer electronic component includes a body having a dielectric layer and first and second internal electrodes alternately stacked with the dielectric layer. The body has opposing first and second surfaces in a first direction, opposing third and fourth surfaces in a second direction, and opposing fifth and sixth surfaces in a third direction. A first and a second external electrode are formed on the third and fourth surfaces and connected to the first internal electrode, and a third and a fourth external electrode are formed on the fifth and sixth surfaces and connected to the second internal electrode. A dummy pattern is disposed between the second internal electrode and the fifth and sixth surfaces to reduce step portions and enhance reliability.

### CROSS-REFERENCE TO RELATED APPLICATION(S)

This application claims the benefit of priority to Korean Patent Application No. 10-2024-0197581 filed on Dec. 26, 2024, with the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-shaped capacitor mounted on the printed circuit boards of various types of electronic products such as video devices such as Liquid Crystal Displays (LCDs) and Plasma Display Panels (PDPs), computers, smartphones and mobile phones, and the circuits of the onboard charger (OBC) DC-DC converter of electric vehicles, and the like, and playing a role in charging or discharging electricity.

In addition to the two-terminal MLCC having two external electrodes, three-terminal or four-terminal MLCCs with altered structures of internal and external electrodes have been developed to improve frequency characteristics.

An MLCC of the three-terminal type has a structure in which a signal internal electrode and a ground internal electrode are alternately stacked, and since the ground internal electrode pattern should be drawn out in a different direction from that of the signal internal electrode pattern, an area in which the internal electrode pattern formed on the dielectric layer during a stacking and compression process of a stack body may be wider than that of the MLCC of the two-terminal type, and an occurrence of a step portion therefrom may also be more severe than that of the MLCC of the two-terminal type.

On the other hand, the step portion generated during the stacking and compression process to form a body of the MLCC may cause stress imbalance in the body, which may reduce the mechanical strength of the MLCC, and may cause the internal electrode to be bent and the density of the dielectric layer to decrease, which may lower the reliability of the MLCC.

Accordingly, there is a need for structural improvement of the MLCC that may alleviate the step portion generated by a region in which the internal electrode is not formed in the MLCC having a three-terminal type.

### SUMMARY

An aspect of the present disclosure is to alleviate a difference between step portions occurring in a three-terminal MLCC.

An aspect of the present disclosure is to minimize a side effect occurring when forming a dummy pattern in a margin portion of a ground internal electrode to alleviate a difference between step portions occurring in a three-terminal MLCC.

However, the aspects of the present disclosure are not limited to the above-described contents, and may be more easily understood in the process of describing specific example embodiments of the present disclosure.

A multilayer electronic component according to an example embodiment of the present disclosure may include: a body including a dielectric layer and a first internal electrode and a second internal electrode alternately disposed with the dielectric layer, and including a first surface and a second surface opposing each other in a first direction, a third surface and a fourth surface opposing each other in a second direction, perpendicular to the first direction, and a fifth surface and a sixth surface opposing each other in a third direction, perpendicular to the first direction and the second direction; a first external electrode disposed on the third surface and connected to the first internal electrode; a second external electrode disposed on the fourth surface and connected to the first internal electrode; a third external electrode disposed on the fifth surface and connected to the second internal electrode; and a fourth external electrode disposed on the sixth surface and connected to the second internal electrode, and the body further may include a dummy pattern disposed between the second internal electrode and the fifth surface, and between the second internal electrode and the sixth surface.

One effect of the present disclosure is to alleviate a difference between step portions and improve the density of a body periphery by disposing a dummy pattern in a margin portion of a ground internal electrode in a three-terminal MLCC.

One effect of the present disclosure is to prevent or minimize the problem of reliability degradation that may occur when forming a dummy pattern in a margin portion of a ground internal electrode to alleviate a difference between step portions that occurs in a three-terminal MLCC.

However, the various advantageous advantages and effects of the present disclosure are not limited to the above-described contents, and may be more easily understood in the process of explaining specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic perspective view of a body according to an example embodiment;

FIG. 3 schematically illustrates a cross-sectional view taken along line I-I′ of FIG. 1;

FIG. 4 schematically illustrates a cross-sectional view taken along line II-II′ of FIG. 1;

FIG. 5 is a first and second direction cross-sectional view of a multilayer electronic component according to an example embodiment, polished in a first direction up to line A-A′ of FIG. 3;

FIG. 6 is a first and second direction cross-sectional view of a multilayer electronic component according to an example embodiment, polished in a first direction up to line B-B′ of FIG. 3; and

FIG. 7 is an enlarged view of region P of FIG. 6.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to more completely explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

In the drawings, an X-direction may be defined as a direction in which first and second internal electrodes are alternately disposed with the dielectric layer interposed therebetween, or a first direction, and among a Y-direction and a Z-direction, which are directions, perpendicular to the X-direction, the Y-direction may be defined as a second direction, and the Z-direction may be defined as the third direction.

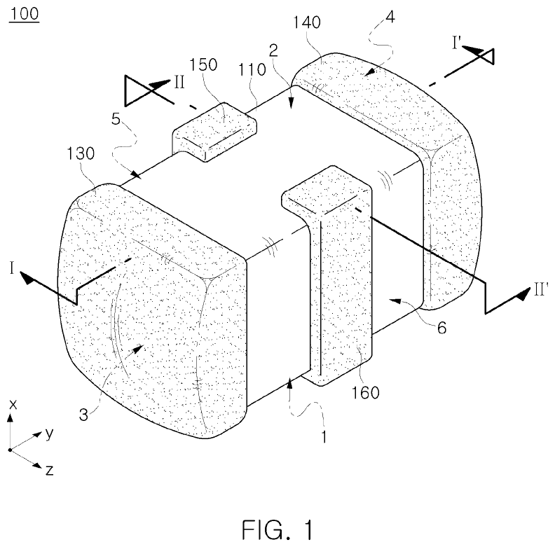

FIG. 1 is a schematic perspective view of a multilayer electronic component according to an example embodiment of the present disclosure.

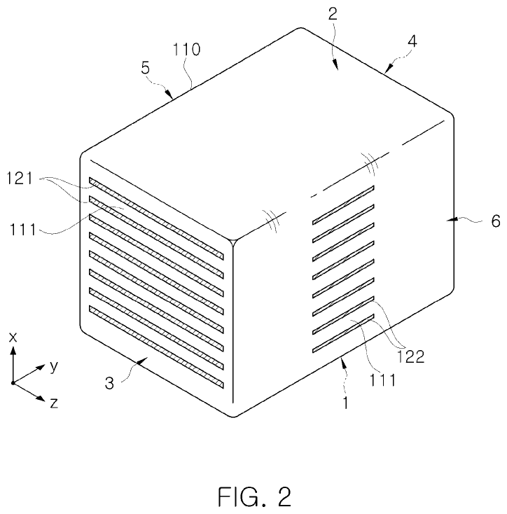

FIG. 2 is a schematic perspective view of a body according to an example embodiment.

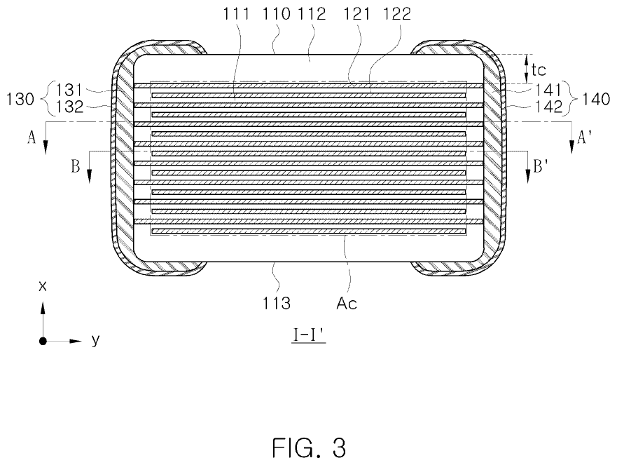

FIG. 3 schematically illustrates a cross-sectional view taken along line I-I′ of FIG. 1.

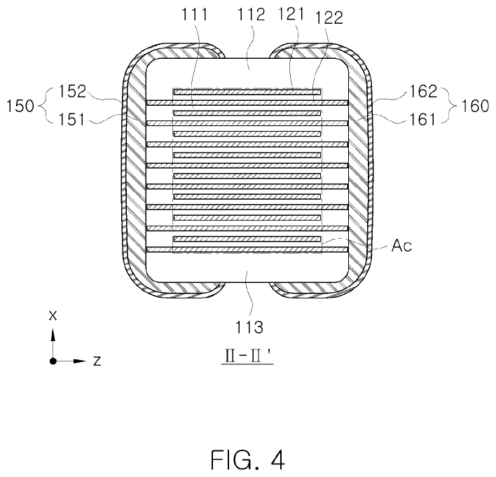

FIG. 4 schematically illustrates a cross-sectional view taken along line II-II′ of FIG. 1.

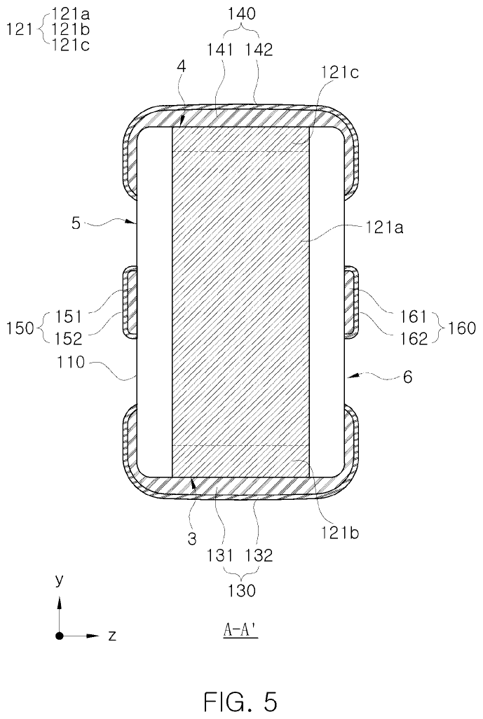

FIG. 5 is a first and second direction cross-sectional view of a multilayer electronic component according to an example embodiment, polished in a first direction up to line A-A′ of FIG. 3.

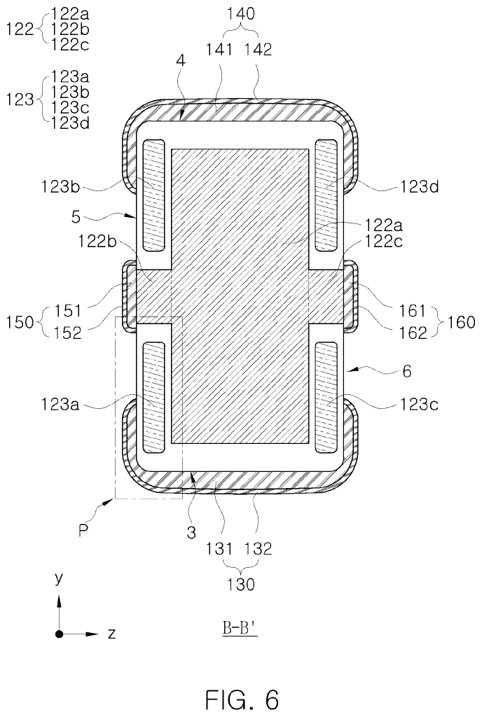

FIG. 6 is a first and second direction cross-sectional view of a multilayer electronic component according to an example embodiment, polished in a first direction up to line B-B′ of FIG. 3.

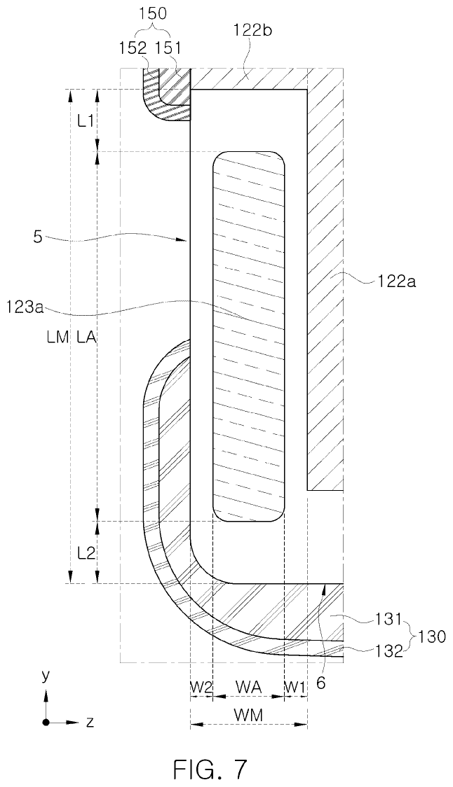

FIG. 7 is an enlarged view of region P of FIG. 6.

Hereinafter, with reference to FIGS. 1 to 7, a multilayer electronic component 100 according to an example embodiment of the present disclosure and various example embodiments thereof will be described in detail. Additionally, a multilayer ceramic capacitor will be described as an example of a multilayer electronic component, but the present disclosure is not limited thereto and may be applied to various multilayer electronic components, such as an inductor, a piezoelectric element, a varistor, or a thermistor.

The multilayer electronic component 100 according to an example embodiment of the present disclosure may include: a body 110 including a dielectric layer 111 and a first internal electrode 121 and a second internal electrode 122 alternately arranged with the dielectric layer 111, and including a first surface 1 and a second surface 2 opposing each other in a first direction, a third surface 3 and a fourth surface 4 opposing each other in a second direction, perpendicular to the first direction, and a fifth surface 5 and a sixth surface 6 opposing each other in a third direction, perpendicular to the first and second directions; a first external electrode 130 disposed on the third surface 3 and connected to the first internal electrode 121; a second external electrode 140 disposed on the fourth surface 4 and connected to the first internal electrode 121; a third external electrode 150 disposed on the fifth surface 5 and connected to the second internal electrode 122; and a fourth external electrode 160 disposed on the sixth surface 6 and connected to the second internal electrode 122, and the body 110 may further include a dummy pattern 123 disposed between the second internal electrode 122 and the fifth surface 5 and between the second internal electrode 122 and the sixth surface 6.

The body 110 may include a dielectric layer 111 and internal electrodes 121 and 122. The dielectric layer 111 and the internal electrodes 121 and 122 may be alternately disposed within the body 110, and a direction in which the internal electrodes 121 and 122 and the body 110 are alternately disposed may be defined as a stacking direction or a first direction.

There is no particular limitation on the specific shape of the body 110, but as illustrated in FIG. 1, the body 110 may be formed into a hexahedron or a similar shape. Additionally, the shape of the body 110 may not be a hexahedron having perfectly straight edges due to shrinkage in a sintering process, or through a separate polishing process, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first and second surfaces 1 and 2 and connected to the third and fourth surfaces 3 and 4 and opposing each other in the third direction. A plurality of dielectric layers 111 forming the body 110 are in a sintered state, and the boundaries between the dielectric layers 111 adjacent to each other may be integrated so as to be difficult to identify without using a scanning electron microscope (SEM).

A main component of the dielectric composition forming the dielectric layer 111 is not particularly limited as long as sufficient electrostatic capacity may be obtained. For example, the dielectric layer 111 may include a perovskite-type compound represented by ABO₃ as a main component. The perovskite compound represented by ABO₃ may include, for example, one or more of BaTiO₃, (Ba1₋ₓCaₓ)TiO₃ (0<x<1), Ba(Ti1-_{y}Ca_{y})O₃ (0<y<1), (Ba1₋ₓCaₓ)(Ti1_{-y}Zr_{y})O₃ (0<x<1, 0<y<1), Ba(Ti1_{-y}Zr_{y})O₃ (0<y<1), CaZrO₃, and (Ca1₋ₓSrₓ)(Zr1_{-y}Ti_{y})O₃ (0<x≤0.5, 0<y≤0.5).

The body 110 may include a capacitance formation portion Ac in which a capacitance is formed, by including the first internal electrode 121 and the second internal electrode 122 disposed inside the body 110 and disposed to face each other with a dielectric layer 111 interposed therebetween.

Additionally, the capacitance formation portion Ac is a portion contributing to the capacitance formation of the capacitor, and may be formed by repeatedly stacking a plurality of first and second internal electrodes 121 and 122 with the dielectric layer 111 interposed therebetween.

Referring to FIG. 2, cover portions 112 and 113 may be disposed on one surface and the other surface of the capacitance formation portion Ac in the first direction. The cover portions 112 and 113 may be formed by stacking a single dielectric layer or two or more dielectric layers in a thickness direction on upper and lower surfaces of the capacitance formation portion Ac, and basically may play a role in preventing damage to the internal electrode due to physical or chemical stress.

The cover portions 112 and 113 do not include an internal electrode, and may include the same material as the dielectric layer 111. That is, the cover portions 112 and 113 may include a ceramic material, and for example, may include the same ceramic material as the dielectric layer 111.

An average thickness tc of the cover portions 112 and 113 is not specifically limited. However, in order to more easily achieve miniaturization and high capacity of the multilayer electronic component, the average thickness tc of the cover portions 112 and 113 may be 15 μm or less.

The average thickness tc of the cover portions 112 and 113 may refer to a first direction size, and may be an average value of the first direction size of the cover portions 112 and 113 measured at five points spaced apart from each other by equal intervals in an upper portion or a lower portion of the capacitance formation portion Ac.

The internal electrodes 121 and 122 may be included in the body 110 together with the dielectric layer 111.

The internal electrodes 121 and 122 may include a first internal electrode 121 and a second internal electrode 122.

The first internal electrode 121 may be connected to the third surface 3 and the fourth surface 4, and may be connected to the first external electrode 130 and the second external electrode 140 described below through the third surface 3 and the fourth surface 4. Meanwhile, the first internal electrode 121 may be spaced apart from the fifth surface 5 and the sixth surface 6.

Referring to FIG. 5, the first internal electrode 121 may include a first main portion 121a overlapping the second internal electrode 122 in the first direction, and first lead portions 121b and 121c extending from the first main portion 121a in the second direction.

The first lead portions 121b and 121c may include a first-first lead portion 121b in which an end thereof is in direct contact with the first external electrode 130 and a first-second lead portion 121c in which an end thereof is in direct contact with the second external electrode 140.

A shape of the first internal electrode 121 is not particularly limited, but may have a shape in which third direction widths thereof are substantially the same in the second direction.

The second internal electrode 122 may be connected to the fifth surface 5 and the sixth surface 6, and may be connected to the third external electrode 150 and the fourth external electrode 160 described below through the fifth surface 5 and the sixth surface 6. Meanwhile, the second internal electrode 122 may be spaced apart from the third surface 3 and the fourth surface 4.

Referring to FIG. 6, the second internal electrode 122 may include a second main portion 122a overlapping the first internal electrode 121 in the first direction, and second lead portions 122b and 122c extending from the second main portion 122a in the third direction.

The second lead portions 122b and 122c may include a second-first lead portion 122b in which an end thereof is in direct contact with the fifth surface 5 and a second-second lead portion 122c in which an end thereof is in direct contact with the sixth surface 6.

A shape of the second internal electrode 122 is not particularly limited, but the second internal electrode 122 may have a shape in which second direction lengths of the second lead portions 122b and 122c are shorter than a second direction length of the second main portion 122a, and may have a shape in which third direction widths of the second lead portions 122b and 122c are shorter than a third direction width of the second main portion 122a.

The first internal electrode 121 and the second internal electrode 122 may be electrically separated by a dielectric layer 111 disposed therebetween, and may be electrically separated from an external electrode not connected through a space separated from the surface of the body 110.

A material included in the internal electrodes 121 and 122 is not particularly limited, and the material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Referring to FIG. 1, external electrodes 130, 140, 150 and 160 may be disposed on the body 110.

Referring to FIG. 3 and FIG. 4, the external electrodes 130, 140, 150 and 160 may include a first external electrode 130 disposed on the third surface 3 of the body 110 and connected to the first internal electrode 121, a second external electrode 140 disposed on the fourth surface 4 and connected to the first internal electrode 121, a third external electrode 150 disposed on the fifth surface 5 and connected to the second internal electrode 122, and a fourth external electrode 160 disposed on the sixth surface 6 and connected to the second internal electrode 122.

Meanwhile, the external electrodes 130, 140, 150 and 160 may be formed using any material that has electrical conductivity, such as metal, and a specific material may be determined by considering electrical characteristics, structural stability, and the like, and may further have a multilayer structure.

For example, the external electrodes 130, 140, 150 and 160 may include electrode layers 131, 141, 151 and 161 disposed on the body 110 and plating layers 132, 142, 152 and 162 formed on the electrode layers 131, 141, 151 and 161.

For more specific examples of the electrode layers 131, 141, 151 and 161, the electrode layers may be sintered electrodes including conductive metal and glass, or resin-based electrodes including conductive metal and resin.

Additionally, the electrode layers 131, 141, 151 and 161 may be formed in a form in which a sintered electrode and a resin-based electrode are sequentially formed on the body. Additionally, the electrode layers may be formed by transferring a sheet including a conductive metal onto the body, or may be formed by transferring a sheet including a conductive metal onto the sintered electrode.

A material having excellent electrical conductivity may be used as the conductive metal included in the electrode layers 131, 141, 151 and 161, and is not particularly limited. For example, the conductive metal may be at least one of nickel (Ni), copper (Cu), and alloys thereof, and may preferably be copper (Cu) to improve adhesion to the body.

The plating layers 132, 142, 152 and 162 serve to improve the mounting characteristics. The type of the plating layers 132, 142, 152 and 162 is not particularly limited, and may be a plating layer including at least one of Ni, Sn, Pd, and alloys thereof, and may be formed of a plurality of layers.

For a more specific example of the plating layers 132, 142, 152 and 162, the plating layer may be a Ni plating layer or a Sn plating layer, and may be in a form in which a Ni plating layer and a Sn plating layer are sequentially formed on the electrode layers 131, 141, 151 and 161, and may be in a form in which the Sn plating layer, the Ni plating layer, and the Sn plating layer are sequentially formed. Additionally, the plating layer may include a plurality of Ni plating layers and/or a plurality of Sn plating layers.

Meanwhile, a step portion occurring during the stacking and pressing process for forming the body of the MLCC may cause stress imbalance in the body, which may reduce the mechanical strength of the MLCC, and may cause the reliability of the MLCC to decrease, such as bending the internal electrode and reducing the density of the dielectric layer.

Meanwhile, the step portion may be more severe in the case of a three-terminal MLCC due to the structural and morphological differences between the signal internal electrode and the ground internal electrode.

Specifically, in the case of a three-terminal MLCC, since withdrawing portions of the signal internal electrode and the ground internal electrode are formed in different directions, so that a region in which the signal internal electrode and the ground internal electrode overlap each other in the first direction may not be sufficient as compared to an internal electrode structure of a two-terminal MLCC, and as a result, a region in which the internal electrode is not formed on the dielectric layer may increase as compared to the two-terminal MLCC structure.

Accordingly, in an example embodiment of the present disclosure, dummy patterns 123a, 123b, 123c and 123d may be disposed in a region between the second internal electrode 122 and the fifth surface 5 of the body 110, and between the second internal electrode and the sixth surface 6, so that a step portion occurring in the three-terminal MLCC structure may be efficiently alleviated.

Meanwhile, when the dummy patterns 123a, 123b, 123c and 123d are disposed in the region between the second internal electrode 122 and the fifth surface 5 of the body 110, and between the second internal electrode and the sixth surface 6, the region in which the dummy patterns 123a, 123b, 123c and 123d are disposed has a high possibility of causing structural defects such as frequent occurrence of pores due to low firing efficiency. Accordingly, in the case of the dielectric layer 111 in contact with the internal electrodes 121 and 122, the density of the dielectric layer 111 may be secured by providing shrinkage stress to the dielectric layer 111 due to shrinkage of the internal electrodes 121 and 122 during firing, while in the case of the dielectric layer 111 in contact with the dummy pattern 123a, 123b, 123c and 123d, it may be difficult to secure the density after sintering.

Accordingly, in an example embodiment, the dummy patterns 123a, 123b, 123c and 123d disposed between the second internal electrode 122 and the fifth surface 5 of the body 110 and between the second internal electrode and the sixth surface 6 may include at least one of Mg, V, Al, Li, Na, K, Mn, Al, Ba, Si or Y, thereby improving the density of the region of the dielectric layer 111 in which the internal electrodes 121 and 122 are not formed.

Referring to FIG. 6, the dummy patterns 123a, 123b, 123c and 123d may have a substantially rectangular shape in the second direction and third direction cross sections of the multilayer electronic component 100, but the present disclosure is not limited thereto. Meanwhile, the corners of the dummy patterns 123a, 123b, 123c and 123d in the cross-sections of the multilayer electronic component 100 in the second direction and the third direction may be rounded, and accordingly, the effect of alleviating the step portion may be further improved.

Referring to FIG. 6, the dummy patterns 123a, 123b, 123c and 123d may be disposed between the second internal electrode 122 and the fifth surface 5, and between the second internal electrode 122 and the sixth surface 6. A region between the second internal electrode 122 and the fifth surface 5, and between the second internal electrode 122 and the sixth surface 6 may correspond to a widthwise margin of the second internal electrode 122, and may correspond to a region that does not overlap the first internal electrode 121 in the first direction.

In an example embodiment, the dummy patterns 123a, 123b, 123c and 123d may be spaced apart from the second internal electrode 122. Accordingly, the phenomenon of one or more of Mg, V, Al, Li, Na, K, Mn, Al, Ba, Si, and Y included in the dummy patterns 123a, 123b, 123c and 123d diffusing into the capacitance formation portion Ac may be prevented, and accordingly, the reliability of the multilayer electronic component 100 may be secured.

In an example embodiment, the dummy patterns 123a, 123b, 123c and 123d may be spaced apart from the third to sixth surfaces 3, 4, 5 and 6. When the dummy pattern 123a, 123b, 123c and 123d are in contact with at least a portion of a surface of the body 110, as a result of at least a portion of the dummy pattern 123a, 123b, 123c and 123d being exposed to the outside of the body 110, problems such as being connected to a portion of the external electrode 130, 140, 150 and 160 or having reduced moisture resistance reliability may occur. Accordingly, as the dummy patterns 123a, 123b, 123c and 123d are spaced apart from the third to sixth surfaces 3, 4, 5 and 6 as in an example embodiment, the connection between the external electrodes 130, 140, 150 and 160 and the dummy patterns 123a, 123b, 123c and 123d may be prevented, and the problem of reduced moisture resistance reliability may be prevented.

In an example embodiment, the dummy patterns 123a, 123b, 123c and 123d may be misaligned with the first internal electrode 121 in the first direction. The meaning of being misaligned in the first direction refer denote that the dummy patterns 123a, 123b, 123c and 123d do not overlap each other in the first direction. That is, the dummy patterns 123a, 123b, 123c and 123d and the first internal electrode 121 may not overlap each other in the first direction. Accordingly, an area of the region in which the first internal electrode 121 and the second internal electrode 122 overlap each other in the first direction may be increased, thereby improving the capacity per unit volume of the multilayer electronic component 100.

When the dummy patterns 123a, 123b, 123c and 123d include Mg, the form of the Mg is not particularly limited. For example, Mg may exist in the form of an oxide including Mg, or in the form of a carbonate including Mg, or in the form of a mixture thereof. That is, in an example embodiment, the dummy patterns 123a, 123b, 123c and 123d may include at least one of an oxide including Mg and a carbonate including Mg. In this case, a ratio (at%) of a content of magnesium (Mg) to a content of oxygen (O) included in the dummy patterns 123a, 123b, 123c and 123d may satisfy 0 at% to 10 at%.

A method of forming the dummy patterns 123a, 123b, 123c and 123d is not particularly limited. For example, in a process of stacking the first internal electrode 121 and the second internal electrode 122, a paste including Mg powder particles, oxide powder particles including Mg, and carbonate powder particles including Mg may be applied and sintered on the dielectric layer 111 on which a paste for the second internal electrode 122 is not disposed.

Meanwhile, the components included in the dummy patterns 123a, 123b, 123c and 123d and the components included in the dielectric layer 111 may be mutually diffused. Accordingly, the dummy patterns 123a, 123b, 123c and 123d may include some of barium (Ba), titanium (Ti), and other additive elements included in the dielectric layer 111. In this case, a ratio (at%) of a content of magnesium (Mg) to the total elements excluding oxygen (O) included in the dummy patterns 123a, 123b, 123c and 123d may satisfy 0.1 at% or more and 10 at% or less, and accordingly, the effect of alleviating the step portion may be improved, and the problems of reliability and dielectric characteristic degradation due to the presence of excessive magnesium (Mg) may be prevented.

If the ratio (at%) of the content of magnesium (Mg) to the total elements excluding oxygen (O) included in the dummy patterns 123a, 123b, 123c and 123d is less than 0.1 at%, it may be difficult to sufficiently secure the effect of alleviating the step portion by applying shrinkage stress to a surrounding dielectric layer.

If a ratio (at%) of the content of magnesium (Mg) to the total elements excluding oxygen (O) included in the dummy patterns 123a, 123b, 123c and 123d exceeds 10 at%, as a result of the excessive presence of magnesium (Mg) in the dummy patterns 123a, 123b, 123c and 123d, the possibility of excessive diffusion of magnesium (Mg) into the surrounding dielectric layer may increase, and as a P-type of the dielectric layer progresses, a high-temperature reliability deterioration problem may occur.

A method of analyzing the composition of the dummy patterns 123a, 123b, 123c and 123d is not particularly limited. For example, by analyzing four corner regions of a cross-section in which the second internal electrode 122 and the dummy patterns 123a, 123b, 123c and 123d are simultaneously exposed by a polishing process in the first direction of the multilayer electronic component 100 using Scanning Transmission Electron Microscope-Energy Dispersive X-ray Spectroscopy (STEM-EDS), the presence, distribution, and content of a specific element may be measured.

When the dummy patterns 123a, 123b, 123c and 123d are disposed adjacently to or connected to the second internal electrode 122, some of the magnesium (Mg) included in the dummy patterns 123a, 123b, 123c and 123d may diffuse into the second internal electrode 122, which may cause a decrease in the electrical conductivity of the second internal electrode 122.

Accordingly, according to an example embodiment, the dummy patterns 123a, 123b, 123c and 123d may be spaced apart from the second internal electrode 122, and accordingly, the second internal electrode 122 may substantially not include magnesium (Mg). In this case, the meaning that the second internal electrode 122 does not substantially include magnesium (Mg) may denote that when the second internal electrode 122 is analyzed using a composition analysis method such as Scanning Transmission Electron Microscope-Energy Dispersive X-ray Spectroscopy (STEM-EDS), the content of magnesium (Mg) included in the second internal electrode 122 is less than 0.05 at% as compared to the total elements excluding oxygen.

Hereinafter, with reference to FIG. 7, a positional relationship between the second internal electrode 122, the dummy patterns 123a, 123b, 123c and 123d, and a surface of the body 110 will be described in detail. In FIG. 7, a relationship between the first dummy pattern 123a, the second internal electrode 122, the third surface 3 and the fifth surface 5 is described, but the description thereof may be similarly applied to a relationship between the second to fourth dummy patterns 123b, 123c and 123d and the second internal electrode 122, the third to sixth surfaces 3, 4, 5 and 6.

Referring to FIG. 7, in an example embodiment, a second direction length in which the dummy pattern 123a and the second internal electrode 122 are spaced apart from each other may be defined as L1, a second direction length in which the dummy pattern 123a and the third surface 3 are spaced apart from each other may be defined as L2, and a second direction length from a second direction end of the second lead portion 122 b to the third surface 3 may be defined as LM. In this case, L1/LM may satisfy 0.03 or more and 0.97 or less, and L2/LM may satisfy 0.03 or more and 0.97 or less. Accordingly, it may be possible to prevent a situation in which the dummy pattern 123a and the second internal electrode 122 are connected to each other, to prevent a situation in which the dummy pattern 123 is exposed to the fifth surface 5, and to also sufficiently secure the effect of alleviating the step portion of the dummy pattern 123a.

Referring to FIG. 7, in an example embodiment, a third direction width in which the dummy pattern 123a and the second internal electrode 122 are spaced apart from each other may be defined as W1, a third direction width in which the dummy pattern 123a and the fifth surface 5 are spaced apart from each other may be defined as W2, and a third direction width from a third direction end of the second main portion 122a to the fifth surface 5 may be defined as WM. In this case, W1/WM may satisfy 0.03 or more and 0.97 or less, and W2/WM may satisfy 0.03 or more and 0.97 or less. Accordingly, a situation in which the dummy pattern 123a and the second internal electrode 122 are connected to each other may be prevented, and a situation in which the dummy pattern 123 is exposed to the fifth surface 5 may be prevented, and the effect of alleviating the step portion of the dummy pattern 123a may also be sufficiently secured.

Referring to FIG. 7, in an example embodiment, an average length of the dummy pattern 123a in the second direction may be defined as LA, and in this case, LA/LM may satisfy 0.03 or more and 0.97 or less. Accordingly, it may be possible to prevent a situation in which the dummy pattern 123a and the second internal electrode 122 are connected to each other, to prevent a situation in which the dummy pattern 123 is exposed to the third surface 3 and the fifth surface 5, and to also sufficiently secure the effect of alleviating the step portion of the dummy pattern 123a, and to also sufficiently secure the capacity per unit volume of the multilayer electronic component 100.

Referring to FIG. 7, in an example embodiment, an average width of the dummy pattern 123a in the third direction may be defined as WA, and in this case, WA/WM may satisfy 0.03 or more and 0.97 or less. Accordingly, it may be possible to prevent a situation in which the dummy pattern 123a and the second internal electrode 122 are connected to each other, and to prevent a situation in which the dummy pattern 123 is exposed to the third surface 3 and the fifth surface 5, and to also sufficiently secure the effect of alleviating the step portion of the dummy pattern 123a, and to also sufficiently secure the capacity per unit volume of the multilayer electronic component 100.

A method of measuring L1, L2, W1, W2, LM, WM, LA, and WA is not particularly limited. For example, a cross-section of the multilayer electronic component 100 polished in the first direction until the second internal electrode 122 and the dummy pattern 123a are exposed may be measured using an optical microscope or a scanning electron microscope. L1, L2, W1, W2, LM and WM may represent a minimum value of a length or a width between each end, and LA, and WA may represent a maximum value of the length or width.

Although an example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the technical concept of the present disclosure defined by the appended claims, and these replacements, modifications, or changes should be construed as being included in the technical concept of the present disclosure.

In addition, the expression ‘an example embodiment’ used in the present disclosure does not mean the same embodiment, and is provided to emphasize and explain different unique characteristics. However, the example embodiments presented above do not preclude being implemented in combination with the features of another embodiment. For example, although items described in a specific example embodiment are not described in another example embodiment, the items may be understood as a description related to another example embodiment unless a description opposite or contradictory to the items is in another example embodiment.

In the present disclosure, the terms are merely used to describe a specific example embodiment, and are not intended to limit the present disclosure. Singular forms may include plural forms as well unless the context clearly indicates otherwise.

What is claimed is:

1. A multilayer electronic component, comprising:
a body including a dielectric layer and a first internal electrode and a second internal electrode alternately disposed with the dielectric layer, and including a first surface and a second surface opposing each other in a first direction, a third surface and a fourth surface opposing each other in a second direction, perpendicular to the first direction, and a fifth surface and a sixth surface opposing each other in a third direction, perpendicular to the first direction and the second direction;
a first external electrode disposed on the third surface and connected to the first internal electrode;
a second external electrode disposed on the fourth surface and connected to the first internal electrode;
a third external electrode disposed on the fifth surface and connected to the second internal electrode; and
a fourth external electrode disposed on the sixth surface and connected to the second internal electrode,
wherein the body further includes a dummy pattern disposed between the second internal electrode and the fifth surface, and between the second internal electrode and the sixth surface.

2. The multilayer electronic component according to claim 1, wherein the dummy pattern includes at least one element selected from a group consisting of Mg, V, Al, Li, Na, K, Mn, Ba, Si, or Y.

3. The multilayer electronic component according to claim 1, wherein the first internal electrode is connected to the third surface and the fourth surface and is spaced apart from the fifth surface and the sixth surface, and the second internal electrode is connected to the fifth surface and the sixth surface and is spaced apart from the third surface and the fourth surface.

4. The multilayer electronic component according to claim 1, wherein the first internal electrode includes a first main portion overlapping the second internal electrode in a first direction, and a first lead portion extending from the first main portion in a second direction, and
the second internal electrode includes a second main portion overlapping the first internal electrode in the first direction, and a second lead portion extending from the second main portion in a third direction.

5. The multilayer electronic component according to claim 1, wherein the dummy pattern is spaced apart from the second internal electrode.

6. The multilayer electronic component according to claim 1, wherein the dummy pattern is spaced apart from the third to sixth surfaces.

7. The multilayer electronic component according to claim 1, wherein the dummy pattern is misaligned with the first internal electrode in the first direction.

8. The multilayer electronic component according to claim 1, wherein the dummy pattern includes at least one selected from a group consisting of an oxide including Mg or a carbonate including Mg.

9. The multilayer electronic component according to claim 8, wherein a ratio (at%) of a content of magnesium (Mg) to a content of oxygen (O) included in the dummy pattern is greater than 0 at% and less than or equal to 10 at%.

10. The multilayer electronic component according to claim 8, wherein a ratio (at%) of a content of magnesium (Mg) to total elements excluding oxygen (O) included in the dummy pattern is greater than or equal to 0.1 at% and less than or equal to 10 at%.

11. The multilayer electronic component according to claim 4, wherein when a second direction length in which the dummy pattern and the second internal electrode are spaced apart from each other is defined as L1, a second direction length in which the dummy pattern and the third surface are spaced apart from each other is defined as L2, and a second direction length from a second direction end of the second lead portion to the third surface is defined as LM,
L1/LM satisfies 0.03 or more and 0.97 or less, and
L2/LM satisfies 0.03 or more and 0.97 or less.

12. The multilayer electronic component according to claim 4, wherein when a third direction width in which the dummy pattern and the second internal electrode are spaced apart from each other is defined as W1, a third direction width in which the dummy pattern and the fifth surface is spaced apart from each other is defined as W2, and a third direction width from a third direction end of the second main portion to the fifth surface is defined as WM,
W1/WM satisfies 0.03 or more and 0.97 or less, and
W2/WM satisfies 0.03 or more and 0.97 or less.

13. The multilayer electronic component according to claim 4, wherein when a second direction average length of the dummy pattern is defined as LA, and a second direction length from a second direction end of the second lead portion to the third surface is defined as LM,
LA/LM satisfies 0.03 or more and 0.97 or less.

14. The multilayer electronic component according to claim 4, wherein when an average width of the dummy pattern in the third direction is defined as WA, and a third direction width from a third direction end of the main portion to the fifth surface is defined as WM,
WA/WM satisfies 0.03 or more and 0.97 or less.

15. The multilayer electronic component according to claim 1, wherein the dummy pattern has a round shape.

16. The multilayer electronic component according to claim 1, wherein the dummy pattern has a substantially rectangular shape in cross section in the second and third directions, and corners of the dummy pattern in the cross sections in the second and third directions are rounded.
